(19) United States
(12) Patent Application Publication
(10) Pub. No.: US 2023/0317076 A1
(43) Pub. Date: Oct. 5, 2023

(54) INTERACTIVE SYSTEM

(71) Applicant: Honda Motor Co., Ltd., Tokyo (JP)

(72) Inventor: Yohane TAKEUCHI, Saitama (JP)

(73) Assignee: Honda Motor Co., Ltd., Tokyo (JP)

(21) Appl. No.: 18/187,644

(22) Filed: Mar. 21, 2023

(30) Foreign Application Priority Data
Mar. 29, 2022 (JP) 2022-053987

(51) Int. Cl. G10L 15/22

(52) U.S. Cl. CPC G10L 15/22; G10L 2015/223

(57) ABSTRACT

The disclosure provides an interactive system that is easy to manage. The interactive system includes an expert for each topic and an expert selector that selects the expert according to a content of an utterance of a user. The expert includes multiple components. One of the components determines whether information required for a goal of an interaction is complete; and in response to that there is missing information, generates a task for obtaining the missing information, adds a component associated with the task, and executes the task by the component added; and in response to that the information required is complete, outputs a reply to the utterance of the user.

### CROSS-REFERENCE TO RELATED APPLICATION

This application claims the priority benefits of Japanese application no. 2022-053987, filed on Mar. 29, 2022. The entirety of the above-mentioned patent application is hereby incorporated by reference herein and made a part of this specification.

### BACKGROUND

### Technical Field

The disclosure relates to an interactive system.

### Description of Related Art

Module-based systems have been used in practical interactive systems (see, for example, Japanese Patent Laid-Open No. 2016-71050). The interaction management part thereof has been done by programmatic rule-based or learning algorithms. A huge amount of data is required for interaction management done by learning algorithms. If the interaction management is done by programs, the range that can be handled is limited, but the management can be handled without data.

However, in the related technology, if the preconditions, etc. for interaction management are all written in programs, the management becomes complicated and it is not easy to make changes. A technology has also been proposed that allows everything to be described with declarative data, but the processing of preconditions, etc. differs for each application, and on the contrary, it may be difficult to describe without using programs, and it is important to balance the part that can be described with data and the part that can be described with programs.

### SUMMARY

An interactive system according to one aspect of the disclosure includes an expert for each topic; and an expert selector selecting the expert according to a content of an utterance of a user. The expert includes a plurality of components. One of the plurality of components determines whether information required for a goal of an interaction is complete; and in response to that there is missing information, generates a task for obtaining the missing information, adds a component associated with the task, and executes the task by the component added; and in response to that the information required is complete, outputs a reply to the utterance of the user.

### BRIEF DESCRIPTION OF THE DRAWINGS

FIG. 1 is a diagram showing a configuration example of the interactive system according to the embodiment.

FIG. 2 is a diagram showing an overview of processing of the interactive system 1 according to the embodiment.

FIG. 3 is a diagram for illustrating components stored by the expert according to the embodiment.

FIG. 4 is a diagram showing an example of selection and switching of components according to the embodiment.

FIG. 5 is a diagram showing an execution rule of the component in the expert device according to the embodiment.

FIG. 6 is a diagram for illustrating an example according to the embodiment.

### DESCRIPTION OF THE EMBODIMENTS

The disclosure provides an interactive system that is easy to manage.

(1) In view of the above, an interactive system according to one aspect of the disclosure includes an expert for each topic; and an expert selector selecting the expert according to a content of an utterance of a user. The expert includes a plurality of components. One of the plurality of components determines whether information required for a goal of an interaction is complete; and in response to that there is missing information, generates a task for obtaining the missing information, adds a component associated with the task, and executes the task by the component added; and in response to that the information required is complete, outputs a reply to the utterance of the user.

(2) Further, in the interactive system according to one aspect of the disclosure, the component may include at least one of a component name, a list of conditions including a type of utterance and an intent of utterance, an output for the utterance of the user, and a next component name.

(3) Further, in the interactive system according to one aspect of the disclosure, the expert selector may calculate a score of a degree of a domain to which each expert for each topic belongs, and select the expert of the domain with the highest calculated score.

(4) Further, in the interactive system according to one aspect of the disclosure, processing of the component may be Last-In-First-Out processing.

(5) Further, in the interactive system according to one aspect of the disclosure, the expert selector may change the expert selected during interaction based on the utterance of the user.

According to (1) to (5), it is possible to provide an interactive system that is easy to manage.

Hereinafter, an embodiment of the disclosure will be described with reference to the drawings. In the drawings used for the following description, the scale of each member is appropriately changed so that each member has a recognizable size. In all the drawings for illustrating the embodiment, the same reference numerals are used for the parts having the same functions, and repeated descriptions are omitted. In addition, “based on XX” in the present application means “based on at least XX,” and also includes cases based on other elements in addition to XX. Moreover, “based on XX” is not limited to the case of using XX directly, and also includes cases based on what has been calculated or processed with respect to XX. “XX” is an arbitrary element (for example, arbitrary information).

### <Overview>

An interactive system of the embodiment uses an expert system. The interactive system receives an utterance of a user, analyzes the content of the utterance, and selects a corresponding expert from a plurality of experts (components). The interactive system uses the selected expert to output a reply or the like to the utterance.

### <Configuration of the Interactive System>

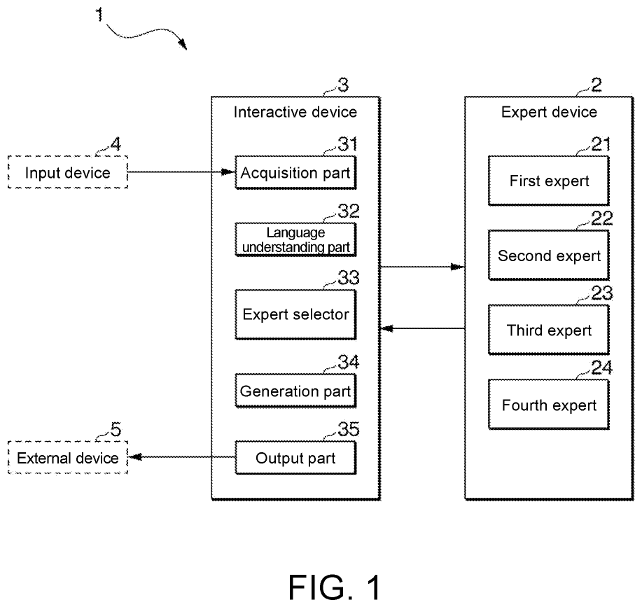

FIG. 1 is a diagram showing a configuration example of the interactive system according to this embodiment. As shown in FIG. 1, the interactive system 1 includes an expert device 2 and an interactive device 3. For example, an input device 4 and an external device 5 are connected to the interactive device 3.

The expert device 2 includes, for example, a first expert 21, a second expert 22, a third expert 23, a fourth expert 24, and so on. The interactive device 3 includes, for example, an acquisition part 31, a language understanding part 32, an expert selector 33, a generation part 34, and an output part 35. The expert device 2 may be included in the interactive device 3.

### <Operation of the Interactive System>

The input device 4 is, for example, a microphone, a microphone array, a keyboard, a touch panel sensor, etc. The input device 4 acquires utterance information of the user and outputs the acquired utterance information to the interactive device 3. Interaction information may be a voice signal or text information.

The external device 5 is, for example, a speaker, an image display device, etc. The external device 5 reproduces or displays an output signal output by the interactive device 3.

The expert device 2 stores an expert for each topic. The first expert 21 is, for example, an expert related to weather. The second expert 22 is, for example, an expert related to cooking. The third expert 23 is, for example, an expert related to travel. The fourth expert 24 is, for example, an expert related to sports. Nevertheless, each expert mentioned above is an example, and the disclosure is not limited thereto. In addition, the configuration of the expert will be described later.

The acquisition part 31 acquires the utterance information from the input device 4.

The language understanding part 32 performs, for example, natural language understanding, dependency analysis, keyword detection, etc. on the acquired utterance information using a language model or the like.

The expert selector 33 selects an expert based on the result understood by the language understanding part 32. For example, the expert selector 33 calculates the score of the degree of the domain to which each expert belongs for each topic, and selects the expert of the domain with the highest calculated score. The selection method will be described later.

The generation part 34 uses the selected expert to generate reply information such as a reply to the utterance of the user.

The output part 35 outputs the reply information generated by the generation part 34 to the external device 5.

### <Outline of Processing of the Interactive System>

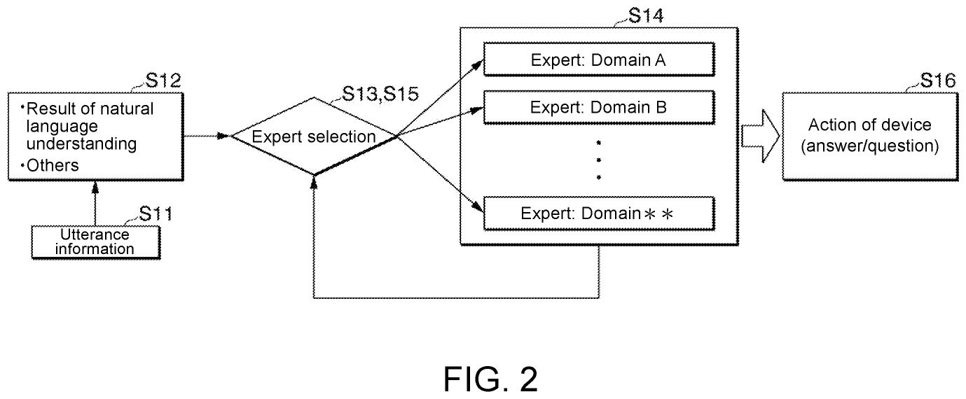

Next, an overview of processing of the interactive system 1 will be described. FIG. 2 is a diagram showing an overview of processing of the interactive system 1 according to this embodiment. (Step S11) The interactive device 3 acquires the utterance information of the user. (Step S12) The interactive device 3 performs processing such as natural language understanding on the acquired utterance information. (Step S13) The interactive device 3 selects an expert by, for example, scoring each expert based on the result of natural language processing or the like. A plurality of experts may be selected. (Step S14) The expert device 2 uses the selected expert to activate the components included in the expert for answering to the user. (Step S15) The interactive device 3 generates an answer using the selected component. The interactive device 3 determines whether the information required for answering to the utterance information of the user is complete. When there is incomplete information, the interactive device 3 activates a component for obtaining the information. (Step S16) When the interactive device 3 determines that the information required for an answer is complete, the interactive device 3 outputs a reply.

### <Component>

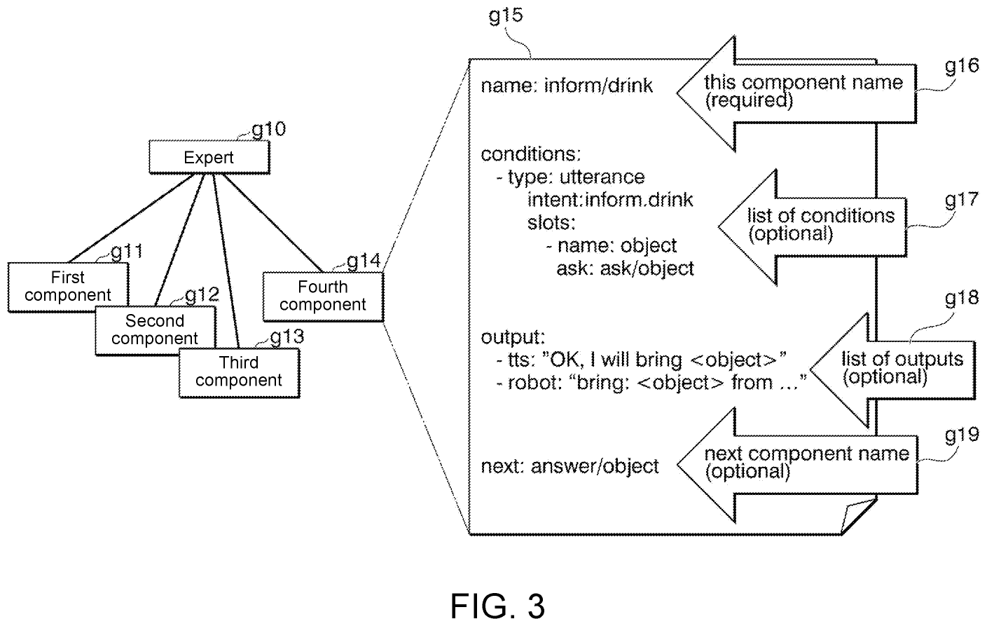

Next, the components stored by the expert will be described. FIG. 3 is a diagram for illustrating components stored by the expert according to this embodiment. Nevertheless, the configuration of the expert and components shown in FIG. 3 is an example, and the disclosure is not limited thereto.

As shown in FIG. 3, for example, the expert g10 includes four components (first component g11 to fourth component g14). The fourth component g14 includes, for example, a component name g16, a condition list g17, an output list g18, and a next component name g19 (g15). The condition list g17, the output list g18, and the next component name g19 are optional and are not necessarily provided.

The condition list g17 includes, for example, the type of utterance information, intent, slots, etc. The output list g18 includes, for example, an answer and a reply object (text file or voice file).

### <Example of Selection and Switching of Components>

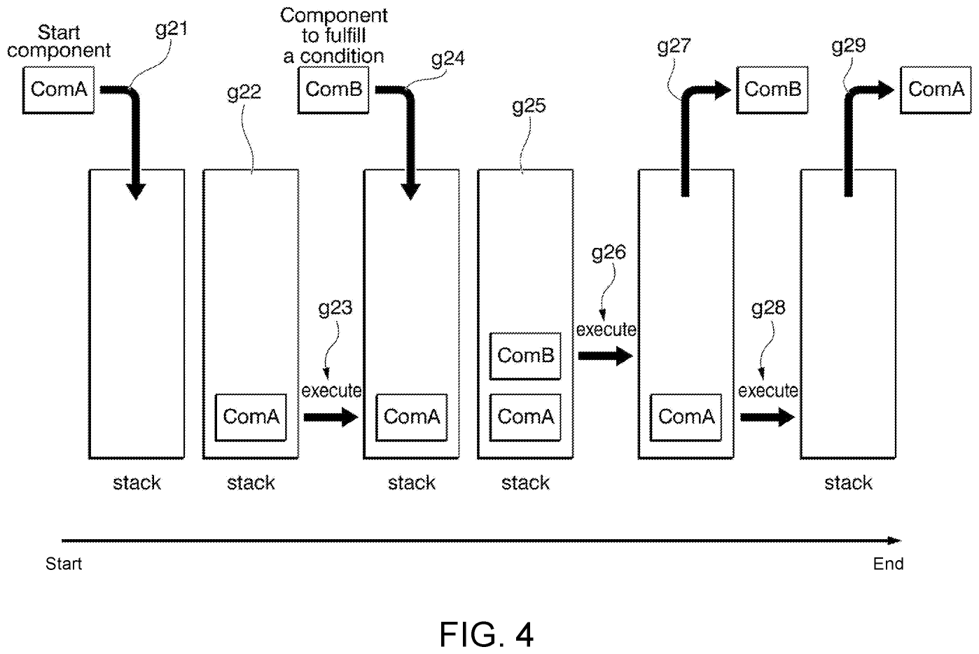

Next, an example of selection and switching of components will be described. FIG. 4 is a diagram showing an example of selection and switching of components according to this embodiment. In FIG. 4, the component is abbreviated as “Com.” In addition, in FIG. 4, the horizontal direction is the progress direction of processing.

First, the expert device 2 puts the component (ComA) included in the selected expert into the stack (g21). As a result, the component (ComA) enters the stack (g22). The expert device 2 activates and executes the component (ComA) (g23).

Next, if there is a condition list in ComA, the information that satisfies the condition is incomplete, so the expert device 2 puts the next component (ComB) included in the selected expert into the stack (g24). As a result, the component (ComA) and the component (ComB) enter the stack (g25). The expert device 2 activates and executes the component (ComB) (g26).

When the information is complete, the expert device 2 takes out the components put into the stack. The expert device 2 first takes out the component (ComB) (g27), executes the component (ComA) (g28), and then takes out the component (ComA) (g29). Thus, in this embodiment, the components are put into and taken out of the stack by Last-In-First-Out.

### <Execution Rule of Component>

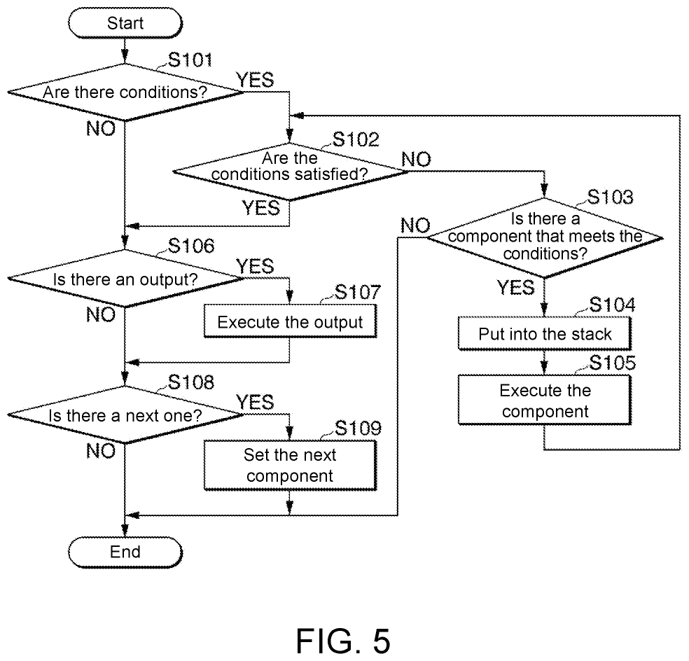

Next, an execution rule of the component will be illustrated. FIG. 5 is a diagram showing the execution rule of the component in the expert device according to this embodiment.

(Step S101) The expert device 2 determines whether there are conditions in the component. If there are conditions (Step S101; YES), the expert device 2 proceeds to the processing of Step S102. If there is no condition (Step S101; NO), the expert device 2 proceeds to the processing of Step S106.

(Step S102) The expert device 2 determines whether the conditions are satisfied. If the conditions are satisfied (Step S102; YES), the expert device 2 proceeds to the processing of Step S106. If the conditions are not satisfied (Step S102; NO), the expert device 2 proceeds to the processing of Step S103.

(Step S103) The expert device 2 determines whether there is a component that meets the conditions. If there is a component to be executed to satisfy the conditions (Step S103; YES), the expert device 2 proceeds to the processing of Step S104. If there is no component that meets the conditions (Step S103; NO), the expert device 2 ends the processing.

(Step S104) The expert device 2 puts the component that meets the conditions into the stack. After the processing, the expert device 2 proceeds to the processing of Step S105.

(Step S105) The expert device 2 executes the component that meets the conditions, which is put into the stack. After the processing, the expert device 2 returns to the processing of Step S102.

(Step S106) The expert device 2 determines whether there is an output in the component. If there is an output (Step S106; YES), the expert device 2 proceeds to the processing of Step S107. If there is no output (Step S106; NO), the expert device 2 proceeds to the processing of step S108.

(Step S107) The expert device 2 executes the output of the component. After the processing, the expert device 2 proceeds to the processing of Step S108.

(Step S108) The expert device 2 determines whether there is a next component name in the component. If there is a next component name (Step S108; YES), the expert device 2 proceeds to the processing of step S109. If there is no next component name (Step S108; NO), the expert device 2 ends the processing.

(Step S109) The expert device 2 sets the next component. After the processing, the expert device 2 ends the processing.

Nevertheless, the rule shown in FIG. 5 is an example, and any rule may be used as long as it corresponds to the list provided by the component.

### EXAMPLE

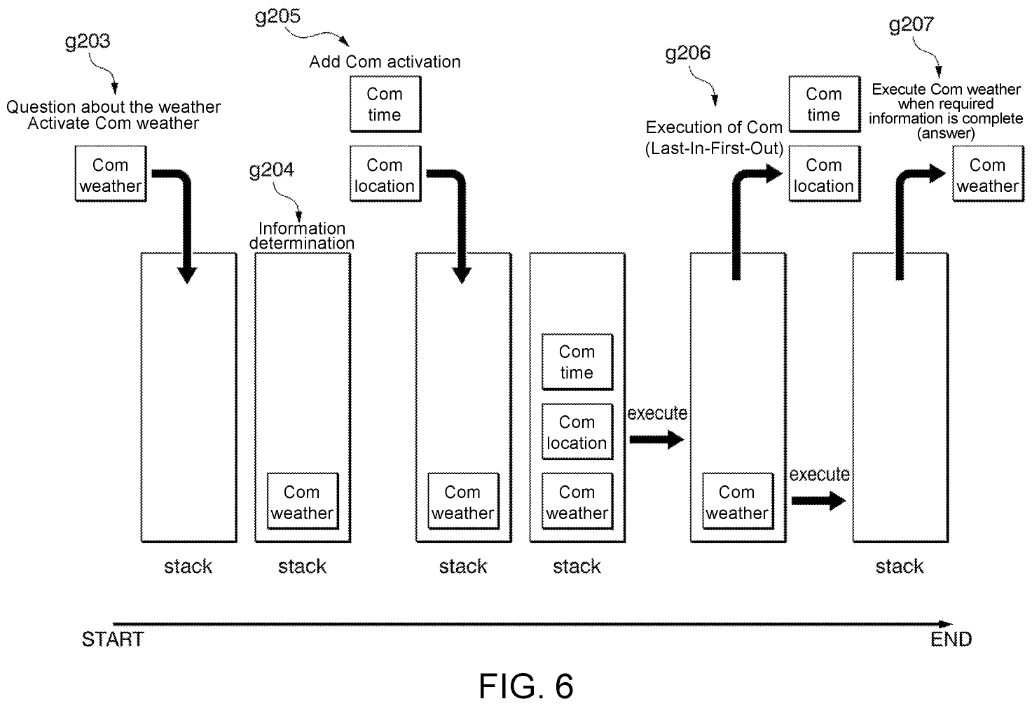

Here, an example of selection of components in the processing of the interactive system and exchanges in the stack will be described. FIG. 6 is a diagram for illustrating the example according to this embodiment. The example of FIG. 6 is an example in which the utterance of the user is a question about the weather. In addition, in FIG. 6, the component is abbreviated as “Com.” In FIG. 6, the horizontal direction is the progress direction of processing. The processing of the following rule is performed by the component.

(Step S201) The interactive device 3 acquires the utterance information “how is the weather?” uttered by the user.

(Step S202) The interactive device 3 determines which expert should respond to the acquired utterance information, for example, by scoring.

(Step S203) The interactive device 3 selects an expert to answer the weather. The expert device 2 puts the component (Com weather) included in the expert that answers the weather into the stack and activates the component to answer the user.

(Step S204) The expert device 2 determines whether the information required for the goal of the interaction is complete from the utterance information. In this example, it is assumed that the information required for the answer of Com weather is location and time.

(Step S205) Since there is information that is incomplete, the expert device 2 puts other components (Com location, Com time) included in the expert that answers the weather into the stack and activates the components to obtain the information.

(Step S206) The expert device 2 executes from the component activated later (Last-In-First-Out). In the example, the question “what is the time of the weather?” asking about the time is executed, and then the question “what is the location of the weather?” is executed.

(Step S207) When the conditions required for an answer are met, the expert device 2 executes Com weather and answers, for example, “tomorrow the weather will be fine here.”

As described above, in this embodiment, it is determined whether the information required for answering the user's question is complete or missing. Then, in this embodiment, if the information required for an answer is missing, the component corresponding to the missing information is added. Then, in this embodiment, in order to obtain the utterance information related to the missing information, the added component is executed to further acquire the utterance information. That is, in this embodiment, when there is missing information, a task for obtaining the missing information is generated, and the component associated with the task is added. Then, in this embodiment, the answer is output after the information is complete.

The execution of each task and the answer to the utterance are held as components for each function. In addition, each component is called for each task, and each component is processed by First-In-Last-Out.

The questions and the components selected in the example shown in FIG. 6 are examples, and the disclosure is not limited thereto. For example, the expert device 2 may change the domain by scoring based on the utterance of the user even when the domain has been selected.

As described above, in this embodiment, which domain (expert) the topic corresponds to is determined by receiving the utterance of the user. Then, in this embodiment, whether it is possible to answer the utterance of the user is determined by the expert corresponding to the domain. Furthermore, in this embodiment, whether the information required for an answer is complete is determined from the information of the utterance of the user. Then, in this embodiment, if the information required for an answer is incomplete, the task to obtain the information from the user (question to the user, etc.) is generated and executed by the component. Then, in this embodiment, when the information is complete, the answer is executed.

Thus, according to this embodiment, it is possible to provide an interactive system that is easy to manage. According to this embodiment, the content of a component can be described as data rather than as programs. Thus, according to this embodiment, separation of programs and data facilitates overall management and changes. It is also more portable than simple flows.

A program for realizing all or some of the functions of the interactive device 3 or the expert device 2 in the disclosure may be recorded in a computer-readable recording medium, and a computer system may be caused to read and execute the program recorded in this recording medium to perform all or part of the processing performed by the interactive device 3 or the expert device 2. The “computer system” referred to here includes hardware such as an OS and peripheral devices. Further, the “computer system” also includes a WWW system provided with a home page providing environment (or display environment). In addition, the “computer-readable recording medium” refers to a portable medium such as a flexible disk, a magneto-optical disk, a ROM, and a CD-ROM, and a storage device such as a hard disk built into the computer system. Furthermore, the “computer-readable recording medium” also includes a medium that holds the program for a certain period of time, like a volatile memory (RAM) inside the computer system that acts as a server or client when the program is transmitted via a network such as the Internet or a communication circuit such as a telephone circuit.

In addition, the above program may be transmitted from the computer system that stores this program in the storage device or the like to another computer system via a transmission medium or by transmission waves in a transmission medium. Here, the “transmission medium” for transmitting the program refers to a medium having a function of transmitting information, like a network (communication network) such as the Internet or a communication circuit (communication line) such as a telephone circuit. Further, the above program may be for realizing some of the functions described above. Furthermore, it may be a so-called difference file (difference program) that can realize the above-described functions in combination with a program already recorded in the computer system.

Although the mode for implementing the disclosure has been described above using the embodiment, the disclosure is by no means limited to such an embodiment, and various modifications and replacements can be made without departing from the gist of the disclosure.

What is claimed is:

1. An interactive system, comprising:
an expert for each topic; and
an expert selector selecting the expert according to a content of an utterance of a user,
wherein the expert comprises a plurality of components, and
one of the plurality of components determines whether information required for a goal of an interaction is complete; and in response to that there is missing information, generates a task for obtaining the missing information, adds a component associated with the task, and executes the task by the component added; and in response to that the information required is complete, outputs a reply to the utterance of the user.

2. The interactive system according to claim 1, wherein the component comprises at least one of a component name, a list of conditions comprising a type of utterance and an intent of utterance, an output for the utterance of the user, and a next component name.

3. The interactive system according to claim 1, wherein the expert selector calculates a score of a degree of a domain to which each expert for each topic belongs, and selects the expert of the domain with the highest calculated score.

4. The interactive system according to claim 2, wherein the expert selector calculates a score of a degree of a domain to which each expert for each topic belongs, and selects the expert of the domain with the highest calculated score.

5. The interactive system according to claim 1, wherein processing of the component is Last-In-First-Out processing.

6. The interactive system according to claim 2, wherein processing of the component is Last-In-First-Out processing.

7. The interactive system according to claim 3, wherein processing of the component is Last-In-First-Out processing.

8. The interactive system according to claim 1, wherein the expert selector changes the expert selected during interaction based on the utterance of the user.

9. The interactive system according to claim 2, wherein the expert selector changes the expert selected during interaction based on the utterance of the user.

10. The interactive system according to claim 3, wherein the expert selector changes the expert selected during interaction based on the utterance of the user.

11. The interactive system according to claim 4, wherein the expert selector changes the expert selected during interaction based on the utterance of the user.
